(19) United States
(12) Patent Application Publication
(10) Pub. No.: US 2024/0093992 A1
(43) Pub. Date: Mar. 21, 2024

(54) BUILDING CHANGE DETECTION DEVICE, BUILDING CHANGE DETECTION SYSTEM, AND BUILDING CHANGE DETECTION METHOD

(71) Applicant: NEC Corporation, Minato-ku, Tokyo (JP)

(72) Inventor: Yuta Goebuchi, Tokyo (JP)

(73) Assignee: NEC Corporation, Minato-ku, Tokyo (JP)

(21) Appl. No.: 18/273,474

(22) PCT Filed: Jan. 29, 2021
(86) PCT No.: PCT/JP2021/003167

§ 371 Date: Jul. 20, 2023

(51) Int. Cl. G01C 15/00; G06T 17/10

(52) U.S. Cl. CPC G01C 15/002; G06T 17/10

(57) ABSTRACT

The purpose of this invention is to provide a building change detection device, and the like, that make it possible to easily compare a three-dimensional model of a building corresponding to individual points in time and a model of the building based on reference information. A building change detection device comprises a measurement data acquisition means for acquiring measurement data indicating the results of measurement based on emitted laser light emitted onto a region under measurement including a building and reflected laser light, a building model generation means for using the measurement data to generate a building model that is a three-dimensional point-cloud model of the building, a building reference model acquisition means for acquiring a building reference model, and a display control means for carrying out control for displaying a first image including the building reference model and the building model.

### TECHNICAL FIELD

The present disclosure relates to a building change detection device and the like.

### BACKGROUND ART

PTL 1 discloses the following technique for an execution site of construction or engineering works. First, three-dimensional models associated with a plurality of points in time (for example, a previous day, the day, and a next day) are generated by using a three-dimensional laser scanner and the like (see a paragraph [0036], a paragraph [0037], FIG. 4, and the like in PTL 1). Secondly, the generated three-dimensional models are displayed. More specifically, the generated three-dimensional models are superimposed and displayed on an actual video (see a paragraph [0038] to a paragraph [0041], and the like in PTL 1). Thirdly, the generated three-dimensional models are compared with a model based on reference information about an execution site.

Herein, the reference information includes, for example, building information modeling (BIM) data or construction information modeling (CIM) data. The model based on the reference information is, for example, a model (so-called “BIM model”) based on the BIM data or a model (so-called “CIM model”) based on the CIM data.

### CITATION LIST

### Patent Literature

PTL 1: Japanese Unexamined Patent Application Publication No. 2019-148946

### SUMMARY OF INVENTION

### Technical Problem

The technique described in PTL 1 generates three-dimensional models associated with a plurality of points in time (for example, a previous day, the day, and a next day), and displays the generated three-dimensional models. In other words, the technique described in PTL 1 does not display a three-dimensional model associated with an individual point in time together with a model based on reference information. Thus, there is a problem that it is difficult to compare a three-dimensional model associated with an individual point in time with a model based on reference information in the technique described in PTL 1.

The present disclosure has been made in order to solve the problem as described above, and an object of the present disclosure is to provide a building change detection device and the like that are able to easily compare a three-dimensional model associated with an individual point in time with a model based on reference information for a building (including architecture, the same applies to description below).

### Solution to Problem

One aspect of a building change detection device according to the present disclosure includes: a measurement data acquisition means for acquiring measurement data indicating a result of a measurement based on applied laser light being applied to a measurement target region including a building, and reflected laser light being reflected by the measurement target region; a building model generation means for generating a building model being a three-dimensional point group model of the building by using the measurement data; a building reference model acquisition means for acquiring a building reference model being a reference model of the building based on reference information about the building; and a display control means for performing control for displaying a first image including the building reference model and the building model.

One aspect of a building change detection method according to the present disclosure includes: acquiring, by a measurement data acquisition means, measurement data indicating a result of a measurement based on applied laser light being applied to a measurement target region including a building, and reflected laser light being reflected by the measurement target region; generating, by a building model generation means, a building model being a three-dimensional point group model of the building by using the measurement data; acquiring, by a building reference model acquisition means, a building reference model being a reference model of the building based on reference information about the building; and performing, by a display control means, control for displaying a first image including the building reference model and the building model.

One aspect of a recording medium according to the present disclosure records a program causing a computer to function as: a measurement data acquisition means for acquiring measurement data indicating a result of a measurement based on applied laser light being applied to a measurement target region including a building, and reflected laser light being reflected by the measurement target region; a building model generation means for generating a building model being a three-dimensional point group model of the building by using the measurement data; a building reference model acquisition means for acquiring a building reference model being a reference model of the building based on reference information about the building; and a display control means for performing control for displaying a first image including the building reference model and the building model.

### Advantageous Effects of Invention

According to the present disclosure, a three-dimensional model associated with an individual point in time is able to be easily compared with a model based on reference information for a building.

### BRIEF DESCRIPTION OF DRAWINGS

FIG. 1 is a block diagram illustrating a main unit of a building change detection system according to a first example embodiment.

FIG. 2 is a block diagram illustrating a hardware configuration of a main unit of a building change detection device according to the first example embodiment.

FIG. 3 is a block diagram illustrating another hardware configuration of a main unit of the building change detection device according to the first example embodiment.

FIG. 4 is a block diagram illustrating another hardware configuration of a main unit of the building change detection device according to the first example embodiment.

FIG. 5 is a flowchart illustrating an operation of the building change detection device according to the first example embodiment.

FIG. 6 is an explanatory diagram illustrating an example of a first image.

FIG. 7 is an explanatory diagram illustrating another example of the first image.

FIG. 8 is a block diagram illustrating a main unit of another building change detection system according to the first example embodiment.

FIG. 9 is a block diagram illustrating a main unit of another building change detection system according to the first example embodiment.

FIG. 10 is a block diagram illustrating a main unit of another building change detection device according to the first example embodiment.

FIG. 11 is a block diagram illustrating a main unit of a building change detection system according to a second example embodiment.

FIG. 12 is a flowchart illustrating an operation of the building change detection device according to the second example embodiment.

FIG. 13 is an explanatory diagram illustrating an example of a second image.

FIG. 14 is an explanatory diagram illustrating another example of the second image.

FIG. 15 is a block diagram illustrating a main unit of a building change detection system according to a third example embodiment.

FIG. 16 is a flowchart illustrating an operation of the building change detection device according to the third example embodiment.

FIG. 17 is an explanatory diagram illustrating an example of a third image.

FIG. 18 is an explanatory diagram illustrating another example of the first image.

FIG. 19 is an explanatory diagram illustrating another example of the first image.

FIG. 20 is a block diagram illustrating a main unit of a building change detection system according to a fourth example embodiment.

FIG. 21 is a flowchart illustrating an operation of a building change detection device according to the fourth example embodiment.

FIG. 22 is an explanatory diagram illustrating an example of a fourth image.

FIG. 23 is an explanatory diagram illustrating another example of the second image.

FIG. 24 is an explanatory diagram illustrating another example of the second image.

### EXAMPLE EMBODIMENT

Hereinafter, example embodiments of the present disclosure are described with reference to accompanying drawings.

### First Example Embodiment

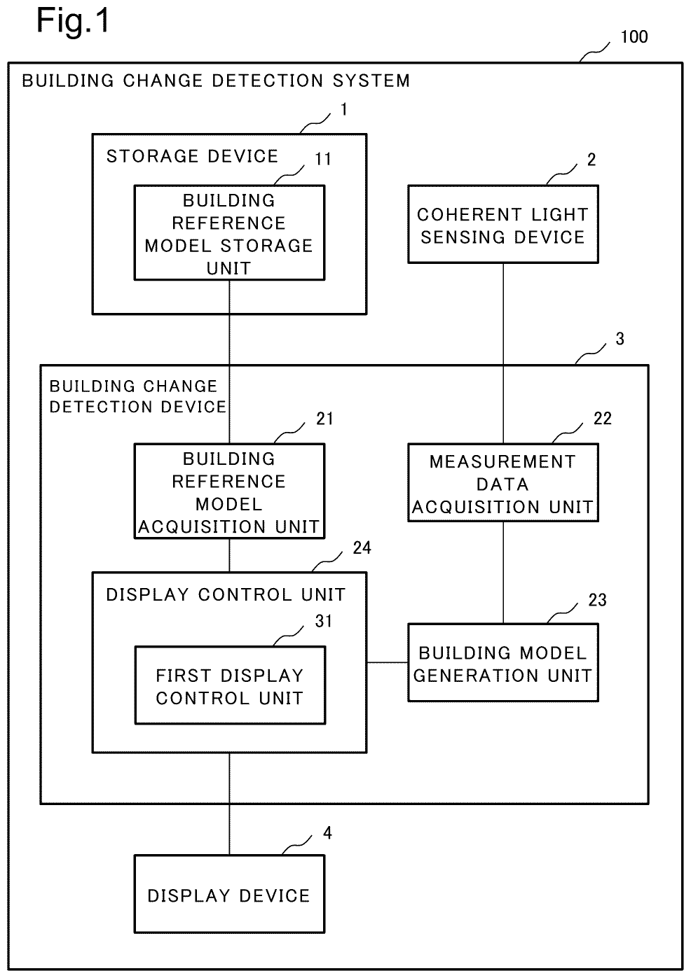

FIG. 1 is a block diagram illustrating a main unit of a building change detection system according to a first example embodiment. The building change detection system according to the first example embodiment will be described with reference to FIG. 1.

As illustrated in FIG. 1, a building change detection system 100 includes a storage device 1, a coherent light sensing device 2, a building change detection device 3, and a display device 4. The storage device 1 includes a building reference model storage unit 11. The building change detection device 3 includes a building reference model acquisition unit 21, a measurement data acquisition unit 22, a building model generation unit 23, and a display control unit 24. The display control unit 24 includes a first display control unit 31.

The building reference model storage unit 11 stores a reference model (hereinafter referred to as a “building reference model”) Mref of a building (hereinafter simply referred to as a “building”) to be a target of a measurement by the coherent light sensing device 2. Herein, the building reference model Mref is based on reference information (hereinafter referred to as “building reference information”) about a building.

The building reference information includes information indicating a shape and dimensions that a building needs to have at at least one point in time, based on a design of the building. In addition to this, the building reference information may include information indicating quality that the building needs to have at the point in time.

Specifically, for example, when the building change detection system 100 is used during construction of a building, the building reference information includes information indicating a shape and dimensions that the building needs to have at a point in time associated with an individual step during the construction. Alternatively, for example, when the building change detection system 100 is used after construction of a building, the building reference information includes information indicating a shape and dimensions that the building needs to have at a time of completion of the building.

The building reference model Mref is a two-dimensional model or a three-dimensional model generated by using the building reference information.

Herein, the building reference information may include BIM data about a building. The building reference model Mref may be a three-dimensional model generated by using the BIM data. In other words, the building reference model Mref may be a BIM model. Hereinafter, an example when the building reference information includes the BIM data will be mainly described. In other words, an example when the building reference model Mref is the BIM model will be mainly described.

The coherent light sensing device 2 measures a building by light detection and ranging (LiDAR). The coherent light sensing device 2 outputs data (hereinafter referred to as “measurement data”) indicating a result of an associated measurement.

In other words, the coherent light sensing device 2 emits laser light. The emitted laser light is applied to a region (hereinafter referred to as a “measurement target region”) including a building. The applied laser light is reflected by an object (including a building) in the measurement target region. The coherent light sensing device 2 receives the reflected laser light. Hereinafter, the laser light applied to the measurement target region may be referred to as “applied laser light”. Further, the laser light reflected by an object in the measurement target region may be referred to as “reflected laser light”.

Herein, an emission direction of the applied laser light is variable in the coherent light sensing device 2. The coherent light sensing device 2 successively emits the applied laser light in a plurality of directions. In this way, the applied laser light is emitted in each of the plurality of directions. In emission in each of the directions, data indicating a one-way propagation distance associated with a round-trip propagation time of the laser light and data indicating an emission direction of the applied laser light are acquired. In addition to this, when the coherent light sensing device 2 is a movable type or a portable type, data indicating an installation position and an installation direction of the coherent light sensing device 2 are acquired. The measurement data output from the coherent light sensing device 2 include the pieces of data.

Note that the coherent light sensing device 2 may be installed in a predetermined position (hereinafter referred to as a “stationary type”). Alternatively, the coherent light sensing device 2 may be a movable type or a portable type. For example, the coherent light sensing device 2 may be mounted on a so-called “drone”. However, from a viewpoint of facilitating setting of a reference point P described below, it is suitable that the coherent light sensing device 2 of a stationary type is used.

In addition, various known techniques can be used for a measurement by LiDAR. Detailed description of the techniques will be omitted.

The building reference model acquisition unit 21 acquires the building reference model Mref stored in the building reference model storage unit 11. Note that, as described above, the building reference model storage unit 11 may store a plurality of the building reference models Mref associated with a plurality of points in time. In this case, the building reference model acquisition unit 21 acquires the building reference model Mref associated with a point in time at which a measurement by the coherent light sensing device 2 is performed.

The measurement data acquisition unit 22 acquires the measurement data output from the coherent light sensing device 2.

The building model generation unit 23 generates a three-dimensional point group model (hereinafter referred to as a “building model”) M of a building by using the measurement data being acquired by the measurement data acquisition unit 22. In other words, the building model generation unit 23 calculates, by using the acquired measurement data, a coordinate value indicating a position of a point at which applied laser light being emitted in each direction is reflected. The coordinate value is a coordinate value in a virtual three-dimensional coordinate space. The three-dimensional point group model (i.e., the building model M) is generated by disposing a point associated with an individual coordinate value in the three-dimensional coordinate space.

In addition, various known techniques can be used for generation of a three-dimensional point group model, based on a result of a measurement by LiDAR. Detailed description of the techniques will be omitted.

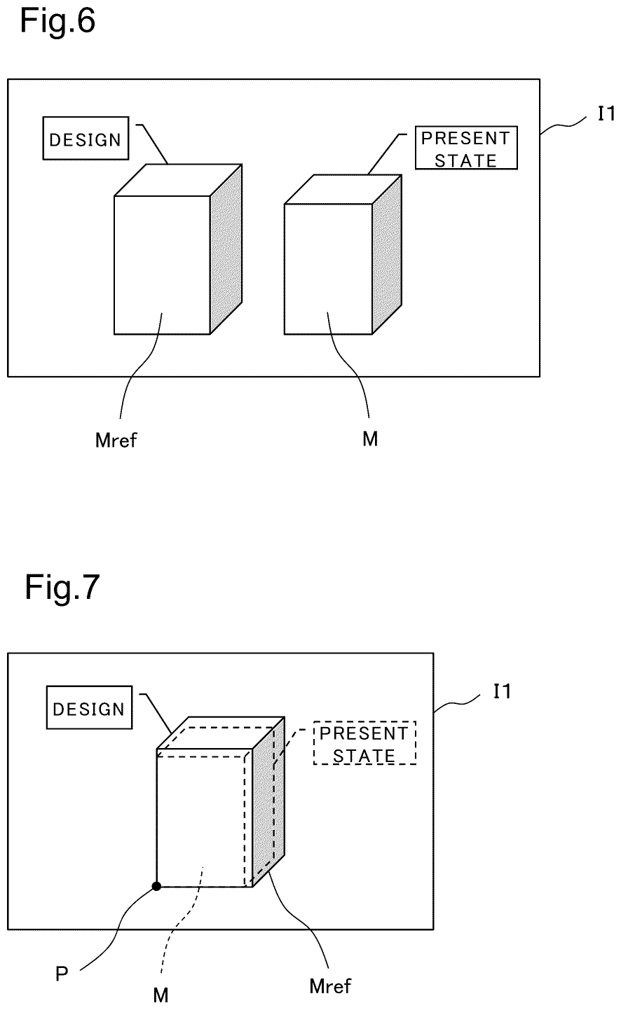

The first display control unit 31 generates an image (hereinafter referred to as a “first image”) I1 including the building reference model Mref being acquired by the building reference model acquisition unit 21 and the building model M being generated by the building model generation unit 23. The first display control unit 31 performs control for displaying the generated first image I1. A specific example of the first image I1 will be described below with reference to FIGS. 6 and 7. The display device 4 is used for the display of the first image I1.

The display device 4 includes a display, a projector, or a printer. Herein, the display may be used for a personal computer (PC). Alternatively, the display may be provided in a portable information terminal.

Specifically, for example, the display may be provided in a smartphone or a tablet terminal. When the building change detection system 100 is used during construction of a building, a portable information terminal may be possessed by a person involved in the construction of the building. On the other hand, when the building change detection system 100 is used after construction of a building, a portable information terminal may be possessed by a person involved in a regular inspection of the building.

In this way, the main unit of the building change detection system 100 is formed.

Hereinafter, the building reference model acquisition unit 21 may be referred to as a “building reference model acquisition means”. Further, the measurement data acquisition unit 22 may be referred to as a “measurement data acquisition means”. Further, the building model generation unit 23 may be referred to as a “building model generation means”. Further, the display control unit 24 may be referred to as a “display control means”.

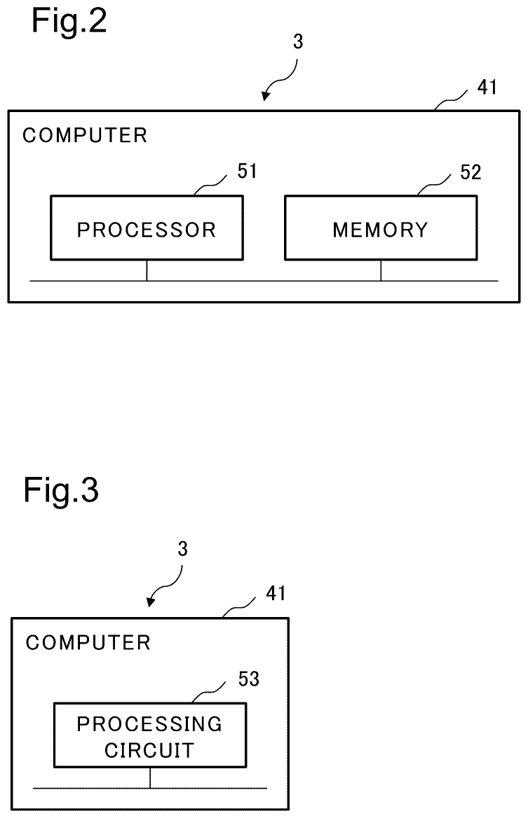

Next, a hardware configuration of a main unit of the building change detection device 3 will be described with reference to FIGS. 2 to 4.

As illustrated in each of FIGS. 2 to 4, the building change detection device 3 uses a computer 41. The computer 41 may be provided at the same place as a place (for example, a construction site of a building) where the coherent light sensing device 2 is installed. Alternatively, the computer 41 may be provided at another place (for example, in a cloud network). Alternatively, a part of elements of the computer 41 may be provided at the same place, and remaining elements of the computer 41 may also be provided at the another place.

As illustrated in FIG. 2, the computer 41 includes a processor 51 and a memory 52. The memory 52 stores a program causing the computer 41 to function as the building reference model acquisition unit 21, the measurement data acquisition unit 22, the building model generation unit 23, and the display control unit 24. The processor 51 reads and executes the program stored in the memory 52. In this way, a function F1 of the building reference model acquisition unit 21, a function F2 of the measurement data acquisition unit 22, a function F3 of the building model generation unit 23, and a function F4 of the display control unit 24 are achieved.

Alternatively, as illustrated in FIG. 3, the computer 41 includes a processing circuit 53. The processing circuit 53 performs processing for causing the computer 41 to function as the building reference model acquisition unit 21, the measurement data acquisition unit 22, the building model generation unit 23, and the display control unit 24. In this way, the functions F1 to F4 are achieved.

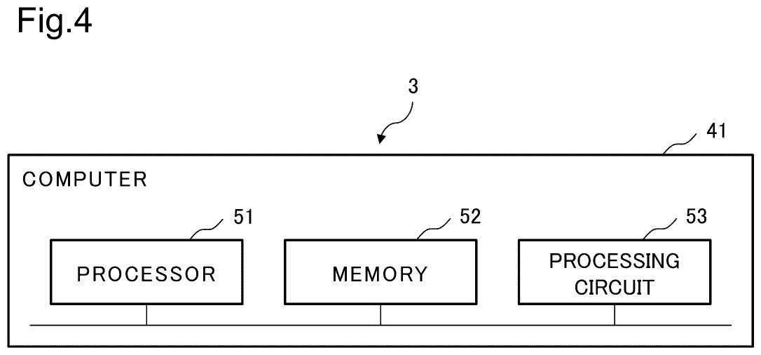

Alternatively, as illustrated in FIG. 4, the computer 41 includes the processor 51, the memory 52, and the processing circuit 53. In this case, a function of a part of the functions F1 to F4 is achieved by the processor 51 and the memory 52, and a remaining function of the functions F1 to F4 is achieved by the processing circuit 53.

The processor 51 is formed of one or more processors. The individual processor uses, for example, a central processing unit (CPU), a graphics processing unit (GPU), a microprocessor, a microcontroller, or a digital signal processor (DSP).

The memory 52 is formed of one or more memories. The individual memory uses, for example, a random access memory (RAM), a read only memory (ROM), a flash memory, an erasable programmable read only memory (EPROM), an electrically erasable programmable read only memory (EEPROM), a solid state drive, a hard disk drive, a flexible disk, a compact disk, a digital versatile disc (DVD) a Blu-ray disk, a magneto optical (MO) disk, or a mini disk.

The processing circuit 53 is formed of one or more processing circuits. The individual processing circuit uses, for example, an application specific integrated circuit (ASIC), a programmable logic device (PLD), a field programmable gate array (FPGA), a system on a chip (SoC), or a system large scale integration (LSI).

Note that the processor 51 may include a special processor associated with each of the functions F1 to F4. The memory 52 may include a special memory associated with each of the functions F1 to F4. The processing circuit 53 may include a special processing circuit associated with each of the functions F1 to F4.

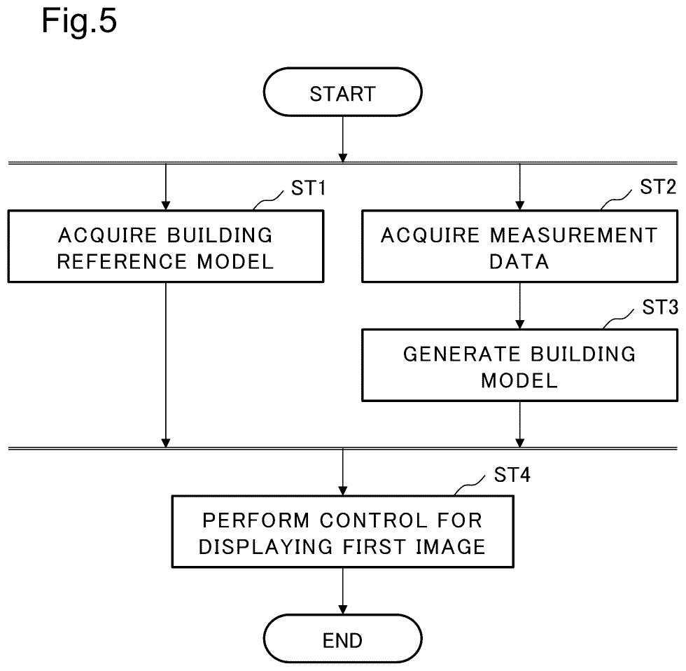

Next, an operation of the building change detection device 3 will be described with reference to a flowchart illustrated in FIG. 5.

First, the building reference model acquisition unit 21 acquires the building reference model Mref (step ST1). In this way, the building reference model Mref associated with a point in time at which a measurement by the coherent light sensing device 2 is performed is acquired.

Further, the measurement data acquisition unit 22 acquires measurement data (step ST2). Next, the building model generation unit 23 generates the building model M (step ST3). The measurement data acquired in step ST2 is used for the generation of the building model M.

Next, the first display control unit 31 performs control for displaying the first image I1 (step ST4). The first image I1 includes the building reference model Mref acquired in step ST1 and the building model M generated in step ST3.

Next, a specific example of the first image I1 will be described with reference to FIGS. 6 and 7.

In the first image I1, each of the building reference model Mref and the building model M may be displayed three-dimensionally. Specifically, for example, each of the building reference model Mref and the building model M may be displayed in a perspective view (see FIGS. 6 and 7). In this case, when the display device 4 includes a display and the display is used for a PC, the models may be rotated in response to an input of an operation to a PC operation input device (for example, a keyboard and a mouse). Further, the models may be zoomed in or out in response to an input of the operation.

Similarly, in this case, when the display device 4 includes a display and the display is provided in a portable information terminal, the models may be rotated in response to an input of an operation to an operation input unit (for example, a touch panel) of the portable information terminal. Further, the models may be zoomed in or out in response to an input of the operation.

Alternatively, each of the building reference model Mref and the building model M may be displayed two-dimensionally in the first image I1. Specifically, for example, each of the building reference model Mref and the building model M may be displayed in a front view, a rear view, a side view, or a plan view (not illustrated).

Herein, the building reference model Mref and the building model M may be displayed side by side in the first image I1 (see FIG. 6). Alternatively, the building model M may be displayed over the building reference model Mref. More specifically, the building model M may be transparently superimposed and displayed on the building reference model Mref (see FIG. 7).

In a case where the building model M is displayed over the building reference model Mref, the first display control unit 31 acquires information indicating the reference point P in each of the building reference model Mref and the building model M when the first image I1 is generated. The first display control unit 31 sets a position of each of the building reference model Mref and the building model M in the first image I1, based on the reference point P. More specifically, the first display control unit 31 matches a position of the reference point P of the building reference model Mref in the first image I1 with a position of the reference point P of the building reference model Mref in the first image I1 (see FIG. 7).

For example, a predetermined portion of a pole of a building or a predetermined portion of a roof of a building is used for the reference point P. In the example illustrated in FIG. 7, a pole (not illustrated) is provided at a corner portion of a building, and a lower end portion of the pole is used for the reference point P.

The information indicating the reference point P in the building reference model Mref is included in, for example, the building reference information. On the other hand, the information indicating the reference point P in the building model M is input by using an operation input device (not illustrated), for example. In other words, the information indicating the reference point P in the building model M is input by a user of the building change detection system 100, for example. In this way, the first display control unit 31 can acquire the pieces of information.

However, when the coherent light sensing device 2 is a stationary type, the reference point P in the building model M can be detected based on a relative position of the portion described above (for example, the lower end portion of the pole) with reference to an installation position of the coherent light sensing device 2. In this case, for example, the building model generation unit 23 may detect the reference point P in the building model M, based on the relative position. In this way, an input of the information described above by a user can be made unnecessary. In other words, setting of the reference point P can be facilitated by using the coherent light sensing device 2 of a stationary type.

Next, an effect by using the building change detection system 100 will be described.

As described above, the first image I1 includes the building reference model Mref and the building model M. More specifically, the building reference model Mref and the building model M are displayed side by side in the first image I1. Alternatively, the building model M is displayed over the building reference model Mref. In other words, the building reference model Mref and the building model M are displayed in a comparable manner with each other. Thus, a user of the building change detection system 100 can easily compare the building model M with the building reference model Mref by viewing the first image I1.

Further, a user of the building change detection system 100 can visually recognize a difference of the building model M from the building reference model Mref by performing the comparison. For example, it is assumed that, during construction of a building, the building reference model Mref indicates a shape of the building that is supposed to be at present, and the building model M indicates an actual shape of the building at present. Further, it is assumed that a person involved in the construction of the building is a user of the building change detection system 100. In this case, the person involved can visually recognize presence or absence of a delay of progress in construction work, based on the difference described above, by viewing the first image I1.

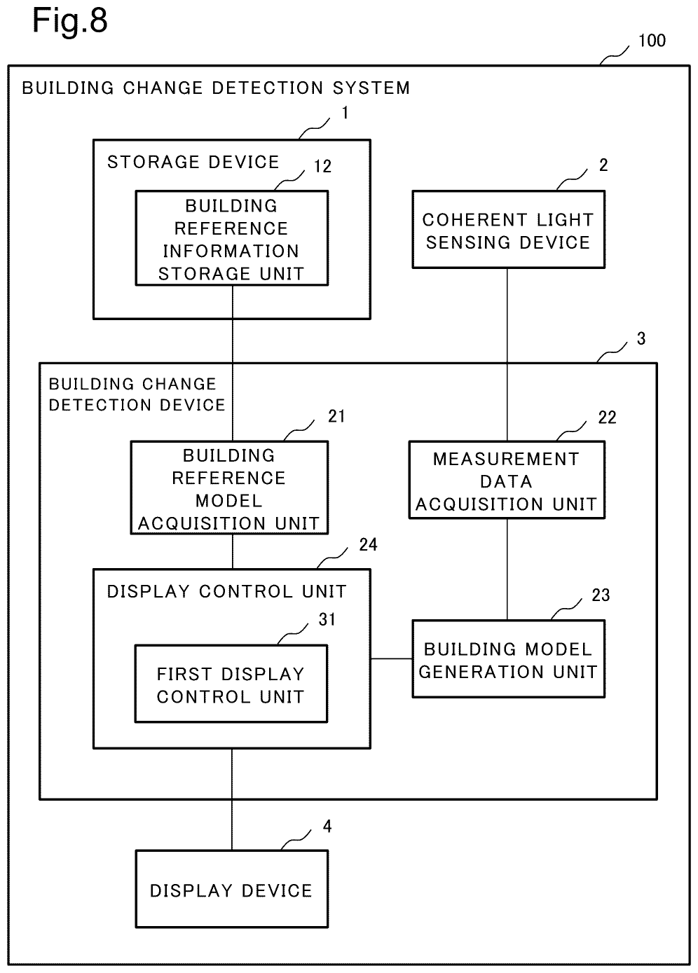

Next, a modification example of the building change detection system 100 will be described with reference to FIG. 8.

As illustrated in FIG. 8, the storage device 1 may include a building reference information storage unit 12 instead of the building reference model storage unit 11. The building reference information storage unit 12 stores building reference information.

In this case, the building reference model acquisition unit 21 acquires the building reference information stored in the building reference information storage unit 12. The building reference model acquisition unit 21 generates the building reference model Mref by using the acquired building reference information. In this way, the building reference model Mref is acquired.

Specifically, for example, the building reference model acquisition unit 21 generates the BIM model by using the BIM data included in the acquired building reference information. Herein, various known techniques can be used for the generation of the BIM model by using the BIM data. Detailed description of the techniques will be omitted.

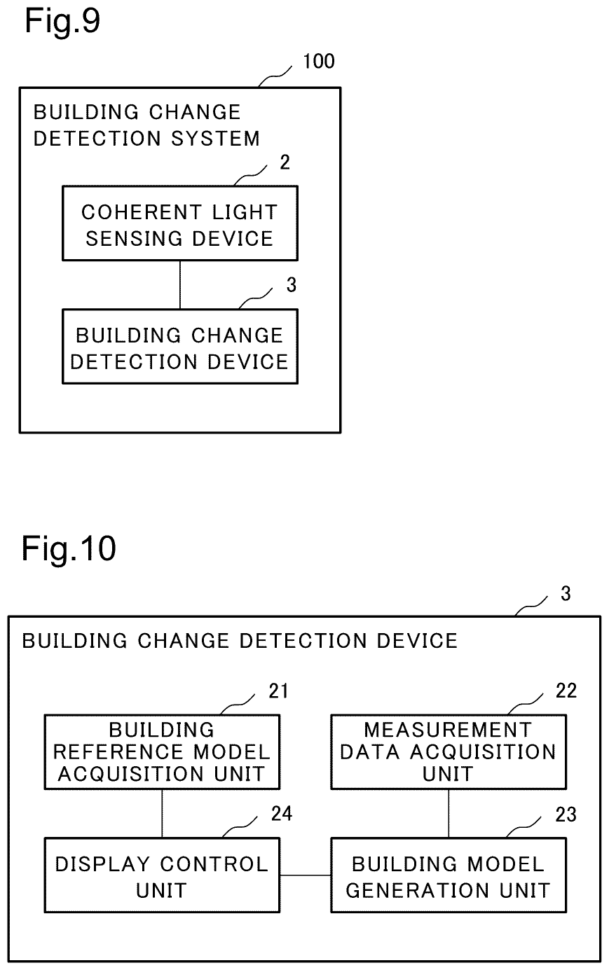

Next, another modification example of the building change detection system 100 will be described with reference to FIG. 9.

As illustrated in FIG. 9, the building change detection system 100 may include the coherent light sensing device 2 and the building change detection device 3. In other words, the coherent light sensing device 2 and the building change detection device 3 may constitute a main unit of the building change detection system 100. In this case, the storage device 1 and the display device 4 may be provided outside the building change detection system 100.

Next, a modification example of the building change detection device 3 will be described with reference to FIG. 10.

As illustrated in FIG. 10, the building change detection device 3 may include the building reference model acquisition unit 21, the measurement data acquisition unit 22, the building model generation unit 23, and the display control unit 24. In other words, the building reference model acquisition unit 21, the measurement data acquisition unit 22, the building model generation unit 23, and the display control unit 24 may constitute a main unit of the building change detection device 3. Even in this case, the effect as described above can be achieved.

In other words, the measurement data acquisition unit 22 acquires measurement data indicating a result of a measurement based on applied laser light being applied to a measurement target region including a building, and reflected laser light being reflected by the measurement target region. The building model generation unit 23 generates the building model M being a three-dimensional point group model of the building by using the measurement data. The building reference model acquisition unit 21 acquires the building reference model Mref being a reference model of the building based on reference information (i.e., building reference information) about the building. The display control unit 24 performs control for displaying the first image I1 including the building reference model Mref and the building model M. The building model M can be easily compared with the building reference model Mref by displaying the first image I1.

### Second Example Embodiment

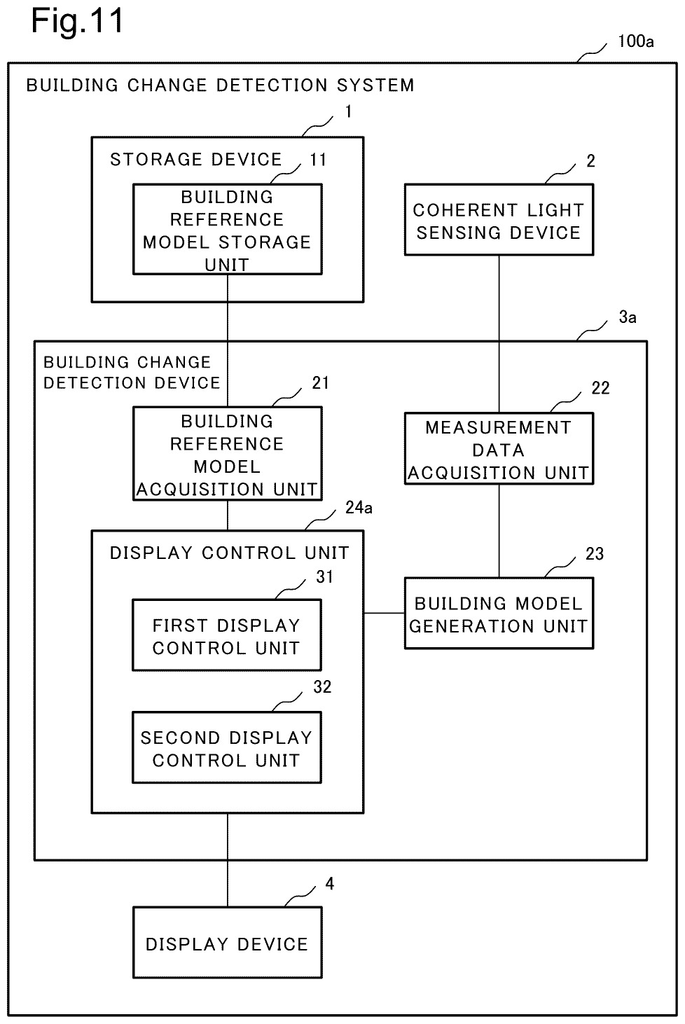

FIG. 11 is a block diagram illustrating a main unit of a building change detection system according to a second example embodiment. The building change detection system according to the second example embodiment will be described with reference to FIG. 11. Note that, a block in FIG. 11 similar to the block illustrated in FIG. 1 is provided with the same reference sign, and the description thereof will be omitted.

As illustrated in FIG. 11, a building change detection system 100a includes a storage device 1, a coherent light sensing device 2, a building change detection device 3a, and a display device 4. The building change detection device 3a includes a building reference model acquisition unit 21, a measurement data acquisition unit 22, a building model generation unit 23, and a display control unit 24a. The display control unit 24a includes a first display control unit 31 and a second display control unit 32.

The coherent light sensing device 2 regularly performs a measurement by LiDAR. In this way, the measurement is performed for a plurality of times. The measurement data acquisition unit 22 acquires data (i.e., measurement data) indicating a result of a measurement each time. The building model generation unit 23 generates a three-dimensional point group model (i.e., a building model M) based on the result of the measurement each time. In this way, a plurality of the building models M associated with a plurality of points in time are generated.

Specifically, for example, the coherent light sensing device 2 performs a measurement by LiDAR every day after construction of a building. In this way, the building model M associated with each day after the construction of the building is generated.

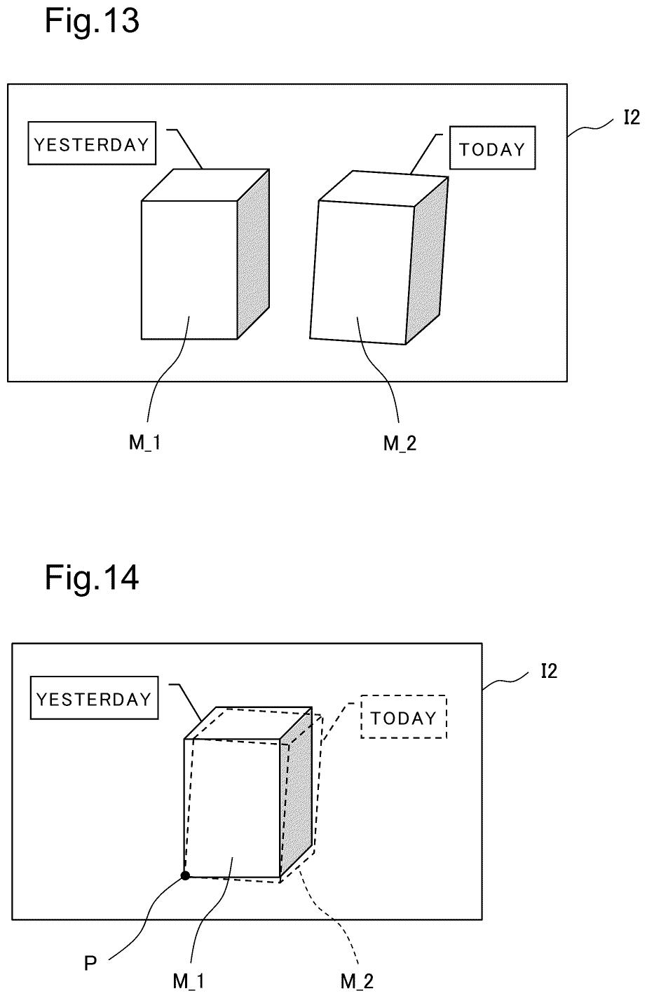

The second display control unit 32 generates an image (hereinafter referred to as a “second image”) 12 including the plurality of building models M. The second display control unit 32 performs control for displaying the generated second image 12. The display device 4 is used for the display of the second image 12. A specific example of the second image 12 will be described below with reference to FIGS. 13 and 14.

In this way, the main unit of the building change detection system 100a is formed.

Hereinafter, the display control unit 24a may be referred to as a “display control means”.

A hardware configuration of a main unit of the building change detection device 3a is similar to that described with reference to FIGS. 2 to 4 in the first example embodiment. Thus, detailed description will be omitted.

In other words, the building change detection device 3a has a function F1 of the building reference model acquisition unit 21, a function F2 of the measurement data acquisition unit 22, a function F3 of the building model generation unit 23, and a function F4a of the display control unit 24a. The functions F1, F2, F3, and F4a may be achieved by a processor 51 and a memory 52. Alternatively, the functions F1, F2, F3, and F4a may be achieved by a processing circuit 53.

Herein, the processor 51 may include a special processor associated with each of the functions F1, F2, F3, and F4a. The memory 52 may include a special memory associated with each of the functions F1, F2, F3, and F4a. The processing circuit 53 may include a special processing circuit associated with each of the functions F1, F2, F3, and F4a.

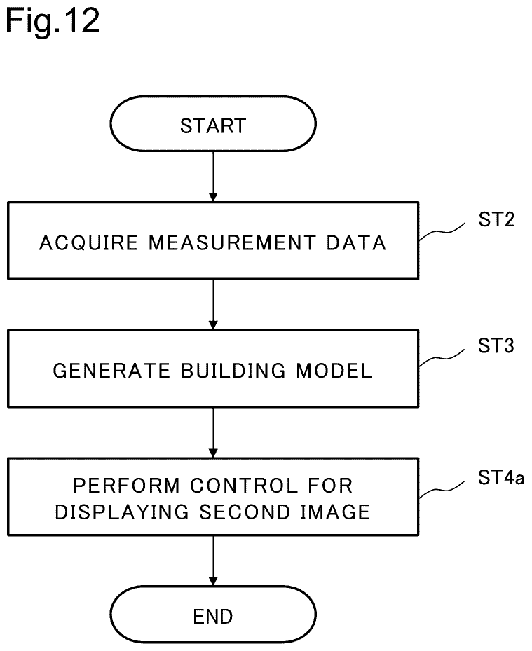

Next, an operation of the building change detection device 3a when the second image 12 is displayed will be mainly described with reference to a flowchart illustrated in FIG. 12. In other words, an operation of the measurement data acquisition unit 22, the building model generation unit 23, and the second display control unit 32 will be mainly described. Note that, a step in FIG. 12 similar to the step illustrated in FIG. 5 is provided with the same reference sign.

First, the measurement data acquisition unit 22 acquires measurement data (step ST2). At this time, the measurement data acquisition unit 22 acquires measurement data indicating a result of a measurement at a plurality of points in time. Specifically, for example, the measurement data acquisition unit 22 acquires measurement data indicating, for example, a result of a measurement yesterday and a result of a measurement today.

Next, the building model generation unit 23 generates the building model M (step ST3). At this time, the building model generation unit 23 generates the plurality of building models M associated with the plurality of points in time by using the measurement data acquired in step ST2. Specifically, for example, the building model generation unit 23 generates a building model M_1 associated with yesterday and a building model M_2 associated with today.

Next, the second display control unit 32 performs control for displaying the second image 12 (step ST4a). The second image 12 includes the plurality of building models M generated in step ST3. Specifically, for example, the second image 12 includes the two building models M_1 and M_2.

Next, a specific example of the second image 12 will be described with reference to FIGS. 13 and 14.

In the second image 12, each of the plurality of building models M may be displayed three-dimensionally. Specifically, for example, each of the two building models M_1 and M_2 may be displayed in a perspective view (see FIGS. 13 and 14). In this case, when the display device 4 includes a display and the display is used for a PC, the models may be rotated in response to an input of an operation to a PC operation input device (for example, a keyboard and a mouse). Further, the models may be zoomed in or out in response to an input of the operation.

Similarly, in this case, when the display device 4 includes a display and the display is provided in a portable information terminal, the models may be rotated in response to an input of an operation to an operation input unit (for example, a touch panel) of the portable information terminal. Further, the models may be zoomed in or out in response to an input of the operation.

Alternatively, each of the plurality of building models M may be displayed two-dimensionally in the second image 12. Specifically, for example, each of the two building models M_1 and M_2 may be displayed in a front view, a rear view, a side view, or a plan view (not illustrated).

Herein, the plurality of building models M may be displayed side by side in the second image 12. Specifically, for example, the two building models M_1 and M_2 may be displayed side by side (see FIG. 13).

Alternatively, the plurality of building models M may be displayed in an overlapping manner with each other in the second image 12. Specifically, for example, on one building model M_1 of the two building models M_1 and M_2, the other one building model M_2 of the two building models M_1 and M_2 may be transparently superimposed and displayed (see FIG. 14). In other words, on the building model M_1 associated with an earlier point in time of two points in time, the building model M_2 associated with a later point in time of the two points in time may be transparently superimposed and displayed.

In a case where the plurality of building models M are displayed in an overlapping manner with each other, the second display control unit 32 acquires information indicating a reference point P in each of the building models M when the second image 12 is generated. Herein, the reference point P is similar to that described in the first example embodiment. Thus, description again will be omitted.

Next, an effect by using the building change detection system 100a will be described.

As described above, the second image 12 includes the plurality of building reference models M associated with a plurality of points in time. More specifically, the plurality of building models M are displayed side by side in the second image 12. Alternatively, the plurality of building models M are displayed in an overlapping manner with each other. In other words, the plurality of building models M are displayed in a comparable manner with each other. Thus, a user of the building change detection system 100a can easily compare the plurality of building models M by viewing the second image 12.

Further, a user of the building change detection system 100a can visually recognize a difference of the building model M associated with a later point in time of a plurality of points in time from the building model M associated with an earlier point in time of the plurality of points in time by performing the comparison. For example, it is assumed that a person involved in a regular inspection of a building after construction of the building is a user of the building change detection system 100a. Further, it is assumed that the second image 12 including the building model M_1 associated with yesterday and the building model M_2 associated with today is displayed. In this case, the person involved can visually recognize a change in a state (for example, a tilt) of the building today from a state (for example, a tilt) of the building yesterday, based on the difference described above, by viewing the second image 12. Herein, the building may be an important cultural property. In this way, the building change detection system 100a may be used for monitoring a state of an important cultural property, and the like.

Next, a modification example of the building change detection system 100a will be described. Further, a modification example of the building change detection device 3a will be described.

The building change detection system 100a can adopt various modification examples similar to that described in the first example embodiment. Further, the building change detection device 3a can adopt various modification examples similar to that described in the first example embodiment.

Specifically, for example, similarly to the example illustrated in FIG. 9, the building change detection system 100a may include the coherent light sensing device 2 and the building change detection device 3a. In other words, the coherent light sensing device 2 and the building change detection device 3a may constitute a main unit of the building change detection system 100a.

Further, for example, similarly to the example illustrated in FIG. 10, the building change detection device 3a may include the building reference model acquisition unit 21, the measurement data acquisition unit 22, the building model generation unit 23, and the display control unit 24a. In other words, the building reference model acquisition unit 21, the measurement data acquisition unit 22, the building model generation unit 23, and the display control unit 24a may constitute a main unit of the building change detection device 3a.

Even in this case, the effect as described above can be achieved. In other words, the building model M can be easily compared with a building reference model Mref by using a first image I1. In addition to this, the plurality of building models M associated with a plurality of points in time can be easily compared by using the second image 12.

### Third Example Embodiment

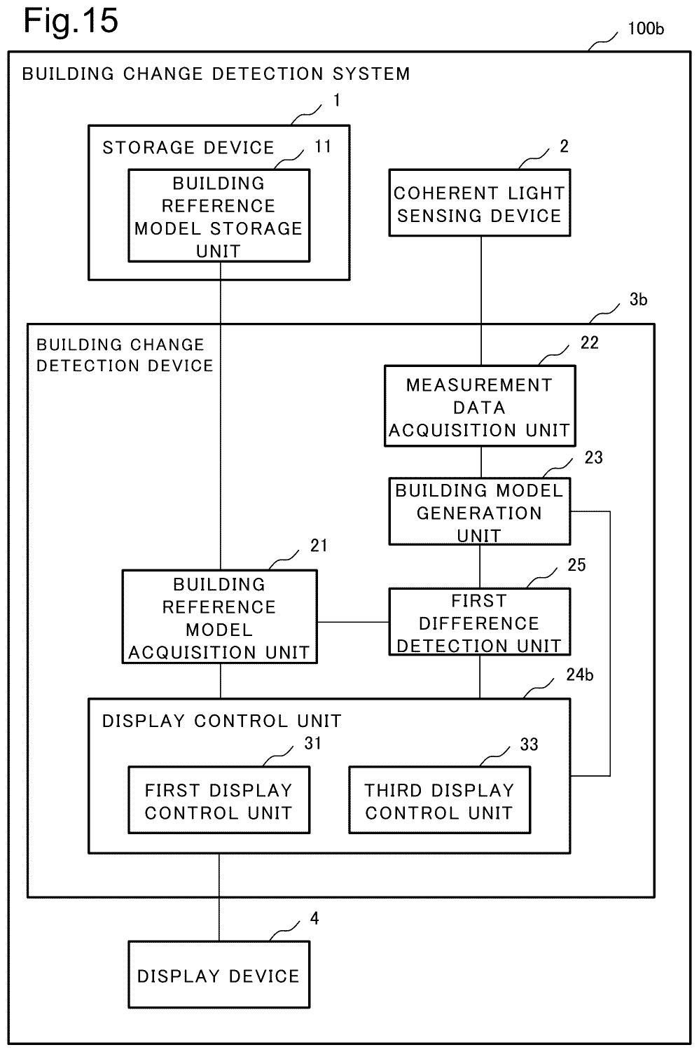

FIG. 15 is a block diagram illustrating a main unit of a building change detection system according to a third example embodiment. The building change detection system according to the third example embodiment will be described with reference to FIG. 15. Note that, a block in FIG. 15 similar to the block illustrated in FIG. 1 is provided with the same reference sign, and the description thereof will be omitted.

As illustrated in FIG. 15, a building change detection system 100b includes a storage device 1, a coherent light sensing device 2, a building change detection device 3b, and a display device 4. The building change detection device 3b includes a building reference model acquisition unit 21, a measurement data acquisition unit 22, a building model generation unit 23, a display control unit 24b, and a first difference detection unit 25. The display control unit 24b includes a first display control unit 31 and a third display control unit 33.

The first difference detection unit 25 compares a building model M being generated by the building model generation unit 23 with a building reference model Mref being acquired by the building reference model acquisition unit 21. In this way, the first difference detection unit 25 detects a difference of the generated building model M from the acquired building reference model Mref.

The third display control unit 33 generates an image (hereinafter referred to as a “third image”) 13 including a result of detection by the first difference detection unit 25. The third display control unit 33 performs control for displaying the generated third image 13. The display device 4 is used for the display of the third image 13. A specific example of the third image 13 will be described below with reference to FIG. 17.

In this way, the main unit of the building change detection system 100b is formed.

Hereinafter, the display control unit 24b may be referred to as a “display control means”. Further, the first difference detection unit 25 may be referred to as a “first difference detection means”.

A hardware configuration of a main unit of the building change detection device 3b is similar to that described with reference to FIGS. 2 to 4 in the first example embodiment. Thus, detailed description will be omitted.

In other words, the building change detection device 3b has a function F1 of the building reference model acquisition unit 21, a function F2 of the measurement data acquisition unit 22, a function F3 of the building model generation unit 23, a function F4b of the display control unit 24b, and a function F5 of the first difference detection unit 25. The functions F1, F2, F3, F4b, and F5 may be achieved by a processor 51 and a memory 52. Alternatively, the functions F1, F2, F3, F4b, and F5 may be achieved by a processing circuit 53.

Herein, the processor 51 may include a special processor associated with each of the functions F1, F2, F3, F4b, and F5. The memory 52 may include a special memory associated with each of the functions F1, F2, F3, F4b, and F5. The processing circuit 53 may include a special processing circuit associated with each of the functions F1, F2, F3, F4b, and F5.

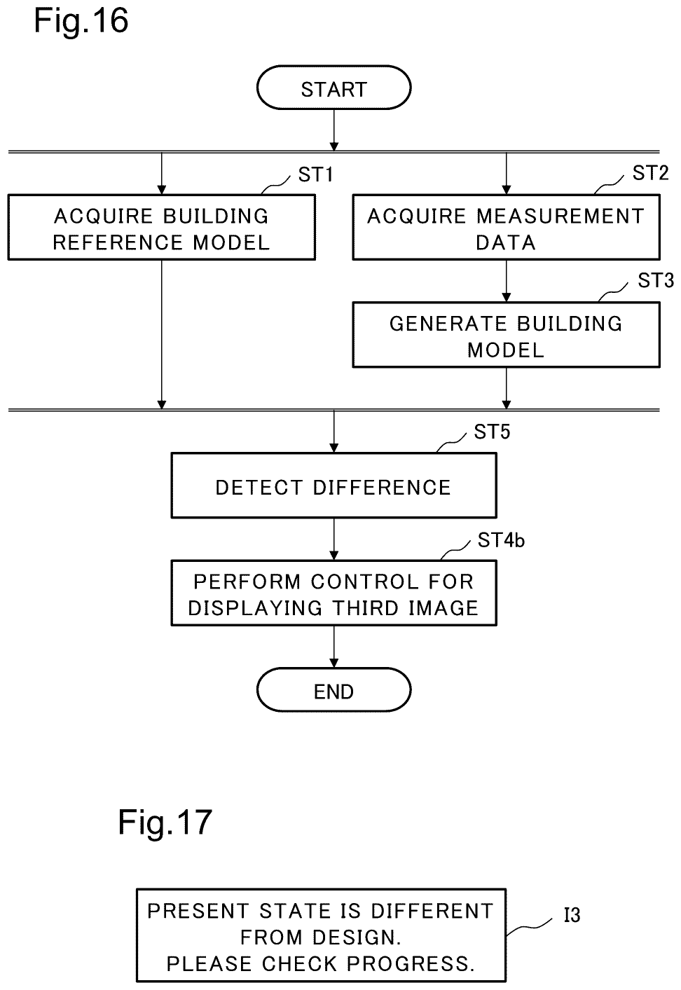

Next, an operation of the building change detection device 3b when the third image 13 is displayed will be mainly described with reference to a flowchart illustrated in FIG. 16. In other words, an operation of the building reference model acquisition unit 21, the measurement data acquisition unit 22, the building model generation unit 23, the first difference detection unit 25, and the third display control unit 33 will be mainly described. Note that, a step in FIG. 16 similar to the step illustrated in FIG. 5 is provided with the same reference sign, and description will be omitted.

First, processing in step ST1 is performed. Further, processing in steps ST2 and ST3 is performed.

Next, the first difference detection unit 25 compares the building model M generated in step ST3 with the building reference model Mref acquired in step ST1. In this way, the first difference detection unit 25 detects a difference of the generated building model M from the acquired building reference model Mref (step ST5).

Next, next, the third display control unit 33 performs control for displaying the third image 13 (step ST4b). The third image 13 includes a result of the detection in step ST5.

Next, a specific example of the third image 13 will be described with reference to FIG. 17.

The third image 13 may include an image in text form (see FIG. 17). For example, when a difference of the building model M from the building reference model Mref is present, the third image 13 may include an image in text form indicating the presence of the difference (“present state is different from design.” in FIG. 17). Further, in this case, the third image 13 may include an image in text form prompting a user of the building change detection system 100b to check (“please check progress.” in FIG. 17).

Alternatively, the third image 13 may include an image in illustration form or an image in icon form (not illustrated). For example, when a difference of the building model M from the building reference model Mref is present, the third image 13 may include an image in illustration form or an image in icon form indicating the presence of the difference. Further, in this case, the third image 13 may include an image in illustration form or an image in icon form prompting a user of the building change detection system 100b to check.

Next, a modification example of the building change detection system 100b will be described.

When a difference is detected by the first difference detection unit 25, the first display control unit 31 may perform control for displaying a first image I1. When a user of the building change detection system 100b performs an input of a predetermined operation while the first image I1 is displayed, the third display control unit 33 may perform control for displaying the third image 13.

At this time, the third image 13 may be displayed over the first image I1. Specifically, for example, the third image 13 may be superimposed and displayed on the first image I1 in a slide-in or pop-up manner.

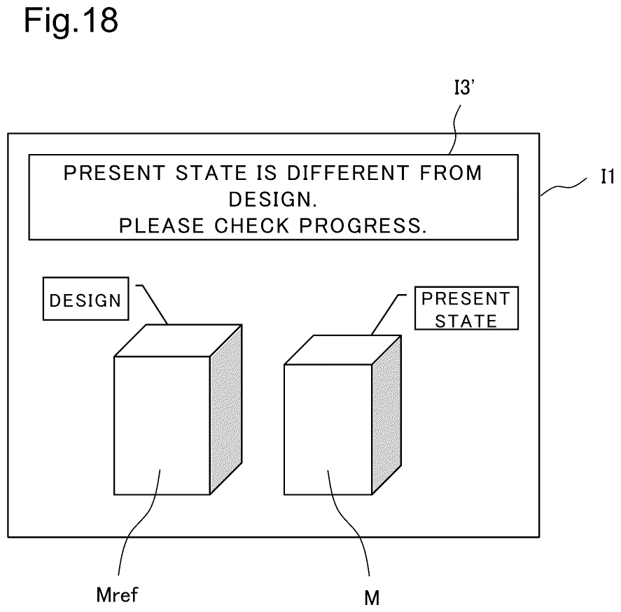

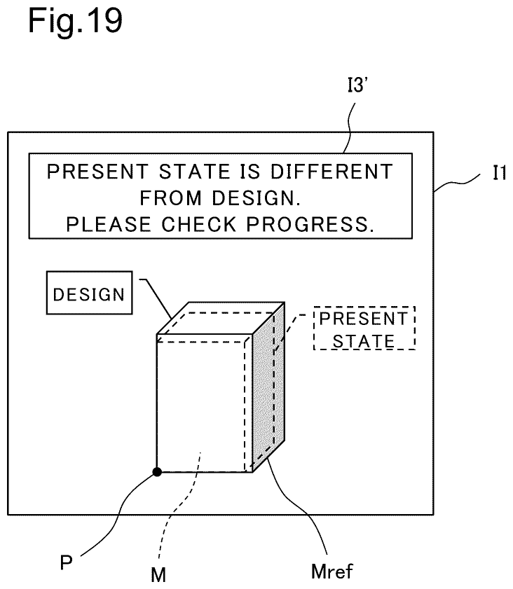

Next, another modification example of the building change detection system 100b will be described with reference to FIGS. 18 and 19.

The first display control unit 31 may perform control as described below instead of the third display control unit 33 performing control for displaying the third image 13. In other words, the first display control unit 31 may perform control for displaying the first image I1 including the building reference model Mref and the building model M and including a result of detection by the first difference detection unit 25.

Specifically, for example, the building reference model Mref and the building model M are displayed side by side in the first image I1. In addition to this, an image 13′ similar to the third image 13 is included in the first image I1 (see FIG. 18).

Alternatively, for example, the building model M is displayed over the building reference model Mref in the first image I1. In addition to this, the image 13′ similar to the third image 13 is included in the first image I1 (see FIG. 19).

Alternatively, for example, the building model M is displayed over the building reference model Mref in the first image I1. Of the overlapped model (Mref, M), a color of a portion associated with a difference detected by the first difference detection unit 25 is displayed in a color different from a color of another portion (not illustrated).

Next, an effect by using the building change detection system 100b will be described.

As described above, in the building change detection system 100b, a result of detection by the first difference detection unit 25 is included in the first image I1 or the third image 13. Thus, a user of the building change detection system 100b can easily visually recognize a difference of the building model M from the building reference model Mref by viewing the first image I1 or the third image 13.

Next, another modification example of the building change detection system 100b will be described. Further, a modification example of the building change detection device 3b will be described.

The building change detection system 100b can adopt various modification examples similar to that described in the first example embodiment. Further, the building change detection device 3b can adopt various modification examples similar to that described in the first example embodiment.

Specifically, for example, similarly to the example illustrated in FIG. 9, the building change detection system 100b may include the coherent light sensing device 2 and the building change detection device 3b. In other words, the coherent light sensing device 2 and the building change detection device 3b may constitute a main unit of the building change detection system 100b.

Further, for example, similarly to the example illustrated in FIG. 10, the building change detection device 3b may include the building reference model acquisition unit 21, the measurement data acquisition unit 22, the building model generation unit 23, the display control unit 24b, and the first difference detection unit 25. In other words, the building reference model acquisition unit 21, the measurement data acquisition unit 22, the building model generation unit 23, the display control unit 24b, and the first difference detection unit 25 may constitute a main unit of the building change detection device 3b.

Even in this case, the effect as described above can be achieved. In other words, the building model M can be easily compared with a building reference model Mref by using the first image I1. In addition to this, a difference of the building model M from the building reference model Mref can be easily visually recognized by using the first image I1 or the third image 13.

### Fourth Example Embodiment

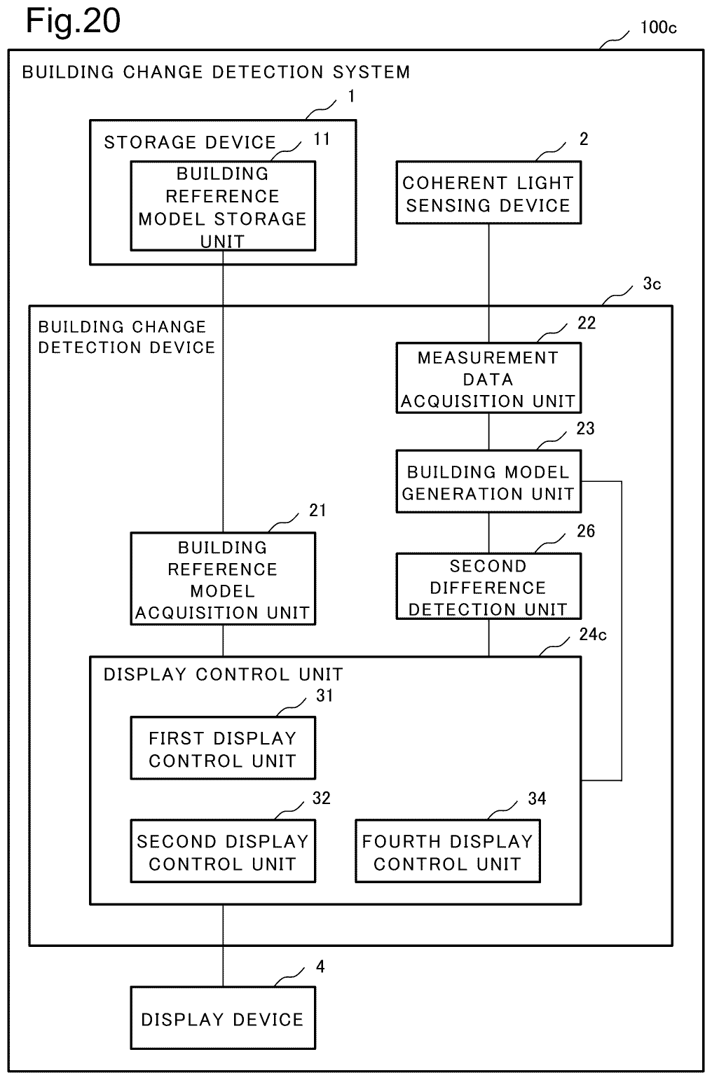

FIG. 20 is a block diagram illustrating a main unit of a building change detection system according to a fourth example embodiment. The building change detection system according to the fourth example embodiment will be described with reference to FIG. 20. Note that, a block in FIG. 20 similar to the block illustrated in FIG. 11 is provided with the same reference sign, and the description thereof will be omitted.

As illustrated in FIG. 20, a building change detection system 100c includes a storage device 1, a coherent light sensing device 2, a building change detection device 3c, and a display device 4. The building change detection device 3c includes a building reference model acquisition unit 21, a measurement data acquisition unit 22, a building model generation unit 23, a display control unit 24c, and a second difference detection unit 26. The display control unit 24c includes a first display control unit 31, a second display control unit 32, and a fourth display control unit 34.

The coherent light sensing device 2 regularly performs a measurement by LiDAR. In this way, the measurement is performed for a plurality of times. The measurement data acquisition unit 22 acquires data (i.e., measurement data) indicating a result of a measurement each time. The building model generation unit 23 generates a three-dimensional point group model (i.e., a building model M) based on the result of the measurement each time. In this way, a plurality of the building models M associated with a plurality of points in time are generated.

The second difference detection unit 26 compares the plurality of building models M with each other. In this way, the second difference detection unit 26 detects a difference between the plurality of building models M.

Specifically, for example, the coherent light sensing device 2 performs a measurement by LiDAR every day after construction of a building. In this way, the building model M associated with each day after the construction of the building is generated. Herein, it is assumed that a building model M_1 associated with yesterday and a building model M_2 associated with today are generated. The second difference detection unit 26 detects a difference of the building model M_2 from the building model M_1.

The fourth display control unit 34 generates an image (hereinafter referred to as a “fourth image”) 14 including a result of detection by the second difference detection unit 26. The fourth display control unit 34 performs control for displaying the generated fourth image 14. The display device 4 is used for the display of the fourth image 14. A specific example of the fourth image 14 will be described below with reference to FIG. 22.

In this way, the main unit of the building change detection system 100c is formed.

Hereinafter, the display control unit 24c may be referred to as a “display control means”. Further, the second difference detection unit 26 may be referred to as a “second difference detection means”.

A hardware configuration of a main unit of the building change detection device 3c is similar to that described with reference to FIGS. 2 to 4 in the first example embodiment. Thus, detailed description will be omitted.

In other words, the building change detection device 3c has a function F1 of the building reference model acquisition unit 21, a function F2 of the measurement data acquisition unit 22, a function F3 of the building model generation unit 23, a function F4c of the display control unit 24c, and a function F6 of the second difference detection unit 26. The functions F1, F2, F3, F4c, and F6 may be achieved by a processor 51 and a memory 52. Alternatively, the functions F1, F2, F3, F4c, and F6 may be achieved by a processing circuit 53.

Herein, the processor 51 may include a special processor associated with each of the functions F1, F2, F3, F4c, and F6. The memory 52 may include a special memory associated with each of the functions F1, F2, F3, F4c, and F6. The processing circuit 53 may include a special processing circuit associated with each of the functions F1, F2, F3, F4c, and F6.

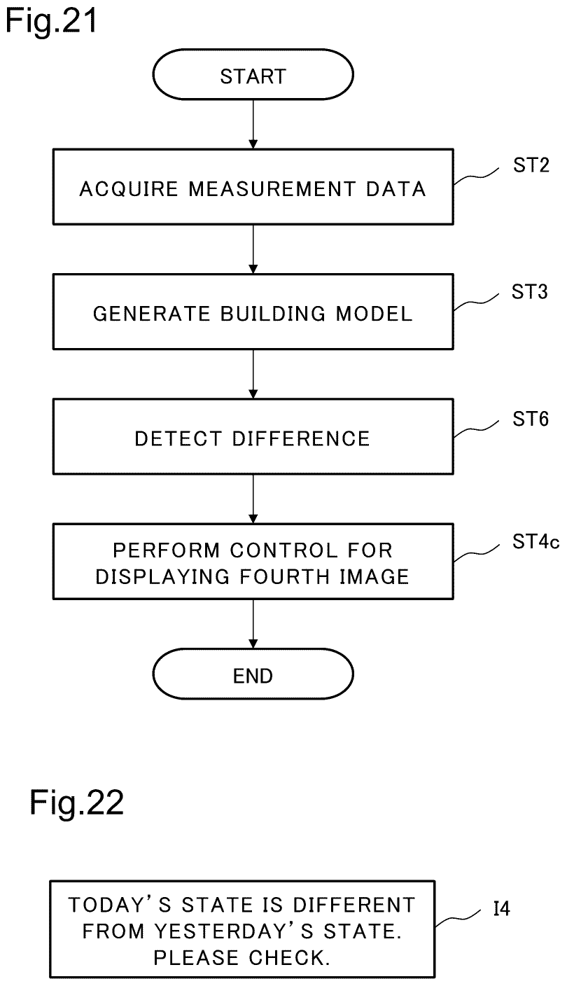

Next, an operation of the building change detection device 3c when the fourth image 14 is displayed will be mainly described with reference to a flowchart illustrated in FIG. 21. In other words, an operation of the measurement data acquisition unit 22, the building model generation unit 23, the second difference detection unit 26, and the fourth display control unit 34 will be mainly described. Note that, a step in FIG. 21 similar to the step illustrated in FIG. 12 is provided with the same reference sign.

First, the measurement data acquisition unit 22 acquires measurement data (step ST2). At this time, the measurement data acquisition unit 22 acquires measurement data indicating a result of a measurement at a plurality of points in time. Specifically, for example, the measurement data acquisition unit 22 acquires measurement data indicating a result of a measurement yesterday and a result of a measurement today.

Next, the building model generation unit 23 generates the building model M (step ST3). At this time, the building model generation unit 23 generates the plurality of building models M associated with the plurality of points in time by using the measurement data acquired in step ST2. Specifically, for example, the building model generation unit 23 generates a building model M_1 associated with yesterday and a building model M_2 associated with today.

Next, the second difference detection unit 26 compares the plurality of building models M generated in step ST2 with each other. In this way, the second difference detection unit 26 detects a difference between the plurality of building models M (step ST6). Specifically, for example, the second difference detection unit 26 detects a difference of the building model M_2 from the building model M_1.

Next, the fourth display control unit 34 performs control for displaying the fourth image 14 (step ST4c). The fourth image 14 includes a result of the detection in step ST6.

Next, a specific example of the fourth image 14 will be described with reference to FIG. 22.

The fourth image 14 may include an image in text form (see FIG. 22). For example, when a difference of the building model M_2 from the building model M_1 is present, the fourth image 14 may include an image in text form indicating the presence of the difference (“today's state is different from yesterday's state.” in FIG. 22). Further, in this case, the fourth image 14 may include an image in text form prompting a user of the building change detection system 100c to check (“please check.” in FIG. 22).

Alternatively, the fourth image 14 may include an image in illustration form or an image in icon form (not illustrated). For example, when a difference of the building model M_2 from the building model M_1 is present, the fourth image 14 may include an image in illustration form or an image in icon form indicating the presence of the difference. Further, in this case, the fourth image 14 may include an image in illustration form or an image in icon form prompting a user of the building change detection system 100c to check.

Next, a modification example of the building change detection system 100c will be described.

When a difference is detected by the second difference detection unit 26, the second display control unit 32 may perform control for displaying a second image 12. When a user of the building change detection system 100c performs an input of a predetermined operation while the second image 12 is displayed, the fourth display control unit 34 may perform control for displaying the fourth image 14.

At this time, the fourth image 14 may be displayed over the second image 12. Specifically, for example, the fourth image 14 may be superimposed and displayed on the second image 12 in a slide-in or pop-up manner.

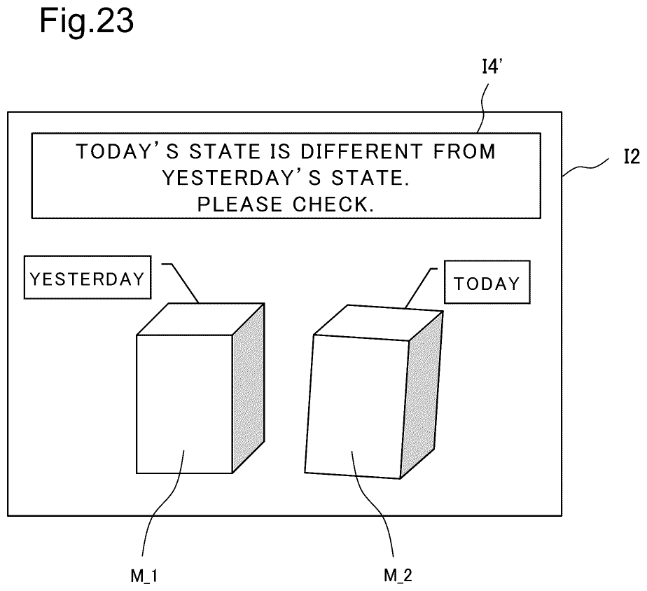

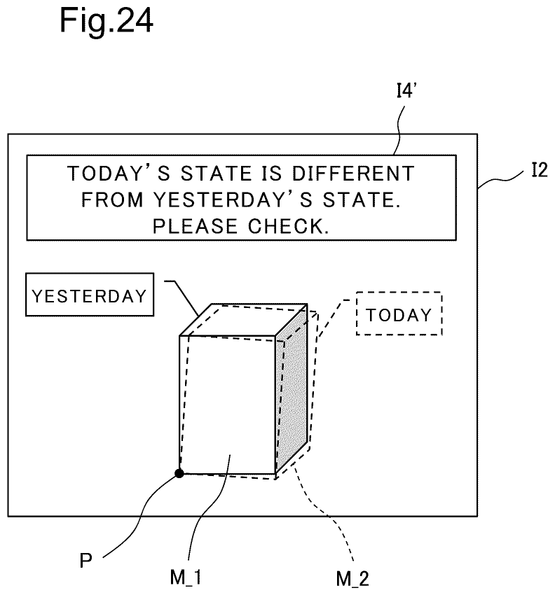

Next, another modification example of the building change detection system 100c will be described with reference to FIGS. 23 and 24.

The second display control unit 32 may perform control as described below instead of the fourth display control unit 34 performing control for displaying the fourth image 14. In other words, the second display control unit 32 may perform control for displaying the second image 12 including the plurality of building models M associated with a plurality of points in time and including a result of detection by the second difference detection unit 26.

Specifically, for example, the building model M_1 and the building model M_2 are displayed side by side in the second image 12. In addition to this, an image 14′ similar to the fourth image 14 is included in the second image 12 (see FIG. 23).

Alternatively, for example, the building model M_2 is displayed over the building model M_1 in the second image 12. In addition to this, the image 14′ similar to the fourth image 14 is included in the second image 12 (see FIG. 24).

Alternatively, for example, the building model M_2 is displayed over the building model M_1 in the second image 12. Of the overlapped model (M_1, M_2), a color of a portion associated with a difference detected by the second difference detection unit 26 is displayed in a color different from a color of another portion (not illustrated).

Next, an effect by using the building change detection system 100c will be described.

As described above, in the building change detection system 100c, a result of detection by the second difference detection unit 26 is included in the second image 12 or the fourth image 14. Thus, a user of the building change detection system 100c can easily visually recognize, by viewing the second image 12 or the fourth image 14, a difference between the plurality of building models M associated with a plurality of points in time.

Next, another modification example of the building change detection system 100c will be described. Further, a modification example of the building change detection device 3c will be described.

The building change detection system 100c can adopt various modification examples similar to that described in the first example embodiment. Further, the building change detection device 3c can adopt various modification examples similar to that described in the first example embodiment.

Specifically, for example, similarly to the example illustrated in FIG. 9, the building change detection system 100c may include the coherent light sensing device 2 and the building change detection device 3c. In other words, the coherent light sensing device 2 and the building change detection device 3c may constitute a main unit of the building change detection system 100c.

Further, for example, similarly to the example illustrated in FIG. 10, the building change detection device 3c may include the building reference model acquisition unit 21, the measurement data acquisition unit 22, the building model generation unit 23, the display control unit 24c, and the second difference detection unit 26. In other words, the building reference model acquisition unit 21, the measurement data acquisition unit 22, the building model generation unit 23, the display control unit 24c, and the second difference detection unit 26 may constitute a main unit of the building change detection device 3c.

Even in this case, the effect as described above can be achieved. In other words, the building model M can be easily compared with a building reference model Mref by using a first image I1. Further, the plurality of building models M associated with a plurality of points in time can be easily compared by using the second image 12. In addition to this, a difference between the plurality of building models M can be easily visually recognized by using the second image 12 or the fourth image 14.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

A part or the whole of the example embodiments described above can be described as, but not limited to, the following supplementary notes.

### [Supplementary Note]

### [Supplementary Note 1]

A building change detection device including:
a measurement data acquisition means for acquiring measurement data indicating a result of a measurement based on applied laser light being applied to a measurement target region including a building, and reflected laser light being reflected by the measurement target region;
a building model generation means for generating a building model being a three-dimensional point group model of the building by using the measurement data;
a building reference model acquisition means for acquiring a building reference model being a reference model of the building based on reference information about the building; and
a display control means for performing control for displaying a first image including the building reference model and the building model.

### [Supplementary Note 2]

The building change detection device according to supplementary note 1, wherein
the building reference model and the building model are displayed in a comparable manner with each other in the first image.

### [Supplementary Note 3]

The building change detection device according to supplementary note 2, wherein
the building reference model and the building model are displayed side by side in the first image.

### [Supplementary Note 4]

The building change detection device according to supplementary note 2, wherein
the building model is displayed over the building reference model in the first image.

### [Supplementary Note 5]

The building change detection device according to any one of supplementary notes 1 to 4, wherein
the building model generation means generates a plurality of the building models associated with a plurality of points in time, and
the display control means performs control for displaying a second image including a plurality of the building models.

### [Supplementary Note 6]

The building change detection device according to supplementary note 5, wherein
a plurality of the building models are displayed in a comparable manner with each other in the second image.

### [Supplementary Note 7]

The building change detection device according to supplementary note 6, wherein
a plurality of the building models are displayed side by side in the second image.

### [Supplementary Note 8]

The building change detection device according to supplementary note 6, wherein
a plurality of the building models are displayed in an overlapping manner with each other in the second image.

### [Supplementary Note 9]

A building change detection system including:
a measurement data acquisition means for acquiring measurement data indicating a result of a measurement based on applied laser light being applied to a measurement target region including a building, and reflected laser light being reflected by the measurement target region;
a building model generation means for generating a building model being a three-dimensional point group model of the building by using the measurement data;
a building reference model acquisition means for acquiring a building reference model being a reference model of the building based on reference information about the building; and
a display control means for performing control for displaying a first image including the building reference model and the building model.

### [Supplementary Note 10]

The building change detection system according to supplementary note 9, wherein
the building reference model and the building model are displayed in a comparable manner with each other in the first image.

### [Supplementary Note 11]

The building change detection system according to supplementary note 10, wherein
the building reference model and the building model are displayed side by side in the first image.

### [Supplementary Note 12]

The building change detection system according to supplementary note 10, wherein
the building model is displayed over the building reference model in the first image.

### [Supplementary Note 13]

The building change detection system according to any one of supplementary notes 9 to 12, wherein
the building model generation means generates a plurality of the building models associated with a plurality of points in time, and
the display control means performs control for displaying a second image including a plurality of the building models.

### [Supplementary Note 14]

The building change detection system according to supplementary note 13, wherein
a plurality of the building models are displayed in a comparable manner with each other in the second image.

### [Supplementary Note 15]

The building change detection system according to supplementary note 14, wherein
a plurality of the building models are displayed side by side in the second image.

### [Supplementary Note 16]

The building change detection system according to supplementary note 14, wherein
a plurality of the building models are displayed in an overlapping manner with each other in the second image.

### [Supplementary Note 17]

A building change detection method including:
acquiring, by a measurement data acquisition means, measurement data indicating a result of a measurement based on applied laser light being applied to a measurement target region including a building, and reflected laser light being reflected by the measurement target region;
generating, by a building model generation means, a building model being a three-dimensional point group model of the building by using the measurement data;
acquiring, by a building reference model acquisition means, a building reference model being a reference model of the building based on reference information about the building; and
performing, by a display control means, control for displaying a first image including the building reference model and the building model.

### [Supplementary Note 18]

The building change detection method according to supplementary note 17, further including
displaying the building reference model and the building model in a comparable manner with each other in the first image.

### [Supplementary Note 19]

The building change detection method according to supplementary note 18, further including
displaying the building reference model and the building model side by side in the first image.

### [Supplementary Note 20]

The building change detection method according to supplementary note 18, further including
displaying the building model over the building reference model in the first image.

### [Supplementary Note 21]

The building change detection method according to any one of supplementary notes 17 to 20, further including:
generating, by the building model generation means, a plurality of the building models associated with a plurality of points in time; and
performing, by the display control means, control for displaying a second image including a plurality of the building models.

### [Supplementary Note 22]

The building change detection method according to supplementary note 21, further including
displaying a plurality of the building models in a comparable manner with each other in the second image.

### [Supplementary Note 23]

The building change detection method according to supplementary note 22, further including
displaying a plurality of the building models side by side in the second image.

### [Supplementary Note 24]

The building change detection method according to supplementary note 22, further including
displaying a plurality of the building models in an overlapping manner with each other in the second image.

### [Supplementary Note 25]

A recording medium recording a program causing a computer to function as:
a measurement data acquisition means for acquiring measurement data indicating a result of a measurement based on applied laser light being applied to a measurement target region including a building, and reflected laser light being reflected by the measurement target region;
a building model generation means for generating a building model being a three-dimensional point group model of the building by using the measurement data;
a building reference model acquisition means for acquiring a building reference model being a reference model of the building based on reference information about the building; and
a display control means for performing control for displaying a first image including the building reference model and the building model.

### [Supplementary Note 26]

The recording medium according to supplementary note 25, wherein
the building reference model and the building model are displayed in a comparable manner with each other in the first image.

### [Supplementary Note 27]

The recording medium according to supplementary note 26, wherein
the building reference model and the building model are displayed side by side in the first image.

### [Supplementary Note 28]

The recording medium according to supplementary note 26, wherein
the building model is displayed over the building reference model in the first image.

### [Supplementary Note 29]

The recording medium according to any one of supplementary notes 25 to 28, wherein
the building model generation means generates a plurality of the building models associated with a plurality of points in time, and
the display control means performs control for displaying a second image including a plurality of the building models.

### [Supplementary Note 30]

The recording medium according to supplementary note 29, wherein
a plurality of the building models are displayed in a comparable manner with each other in the second image.

### [Supplementary Note 31]

The recording medium according to supplementary note 30, wherein
a plurality of the building models are displayed side by side in the second image.

### [Supplementary Note 32]

The recording medium according to supplementary note 30, wherein
a plurality of the building models are displayed in an overlapping manner with each other in the second image.

### REFERENCE SIGNS LIST

1 Storage device
2 Coherent light sensing device
3, 3a, 3b, 3c Building change detection device
4 Display device
11 Building reference model storage unit
12 Building reference information storage unit
21 Building reference model acquisition unit
22 Measurement data acquisition unit
23 Building model generation unit
24, 24a, 24b, 24c Display control unit
25 First difference detection unit
26 Second difference detection unit
31 First display control unit
32 Second display control unit
33 Third display control unit
34 Fourth display control unit
41 Computer
51 Processor
52 Memory
53 Processing circuit
100, 100a, 100b, 100c Building change detection system

What is claimed is:

1. A building change detection device comprising:
at least one memory configured to store instructions; and at least one processor configured to execute the instructions to
acquire measurement data indicating a result of a measurement based on applied laser light being applied to a measurement target region including a building, and reflected laser light being reflected by the measurement target region,
generate a building model being a three-dimensional point group model of the building by using the measurement data,
acquire a building reference model being a reference model of the building based on reference information about the building, and
perform control for displaying a first image including the building reference model and the building model.

2. The building change detection device according to claim 1,
wherein the building reference model and the building model are displayed in a comparable manner with each other in the first image.

3. The building change detection device according to claim 2,
wherein the building reference model and the building model are displayed side by side in the first image.

4. The building change detection device according to claim 2,
wherein the building model is displayed over the building reference model in the first image.

5. The building change detection device according to claim 1,
wherein the at least one processor generates a plurality of the building models associated with a plurality of points in time, and
the at least one processor performs control for displaying a second image including a plurality of the building models.

6. The building change detection device according to claim 5,
wherein a plurality of the building models are displayed in a comparable manner with each other in the second image.

7. The building change detection device according to claim 6,
wherein a plurality of the building models are displayed side by side in the second image.

8. The building change detection device according to claim 6,
wherein a plurality of the building models are displayed in an overlapping manner with each other in the second image.

9. A building change detection system comprising:
at least one memory configured to store instructions; and at least one processor configured to execute the instructions to
acquire measurement data indicating a result of a measurement based on applied laser light being applied to a measurement target region including a building, and reflected laser light being reflected by the measurement target region,
generate a building model being a three-dimensional point group model of the building by using the measurement data,
acquire a building reference model being a reference model of the building based on reference information about the building, and
perform control for displaying a first image including the building reference model and the building model.

10. The building change detection system according to claim 9,
wherein the building reference model and the building model are displayed in a comparable manner with each other in the first image.

11. The building change detection system according to claim 10,
wherein the building reference model and the building model are displayed side by side in the first image.

12. The building change detection system according to claim 10,
wherein the building model is displayed over the building reference model in the first image.

13. The building change detection system according to claim 9,
wherein the at least one processor generates a plurality of the building models associated with a plurality of points in time, and
the at least one processor performs control for displaying a second image including a plurality of the building models.

14. The building change detection system according to claim 13,
wherein a plurality of the building models are displayed in a comparable manner with each other in the second image.

15. The building change detection system according to claim 14,
wherein a plurality of the building models are displayed side by side in the second image.

16. The building change detection system according to claim 14,
wherein a plurality of the building models are displayed in an overlapping manner with each other in the second image.

17. A building change detection method comprising:
acquiring, by at least one memory configured to store instructions; and at least one processor configured to execute the instructions, measurement data indicating a result of a measurement based on applied laser light being applied to a measurement target region including a building, and reflected laser light being reflected by the measurement target region;
generating, by the at least one processor, a building model being a three-dimensional point group model of the building by using the measurement data;
acquiring, by the at least one processor, a building reference model being a reference model of the building based on reference information about the building; and
performing, by the at least one processor, control for displaying a first image including the building reference model and the building model.

18. The building change detection method according to claim 17, further comprising displaying the building reference model and the building model in a comparable manner with each other in the first image.

19. The building change detection method according to claim 18, further comprising displaying the building reference model and the building model side by side in the first image.

20. The building change detection method according to claim 18, further comprising displaying the building model over the building reference model in the first image.

21-24. (canceled)
